(19) United States
(12) Patent Application Publication
(10) Pub. No.: US 2013/0039478 A1
(43) Pub. Date: Feb. 14, 2013

(54) METHOD FOR PRODUCING AN X-RAY SCATTERED RADIATION GRID AND X-RAY SCATTERED RADIATION GRID

(71) Applicants: Mario Bechtold, Hemhofen (DE); Peter Strattner, Heilsbroon (DE)

(72) Inventors: Mario Bechtold, Hemhofen (DE); Peter Strattner, Heilsbroon (DE)

(73) Assignee: Siemens Aktiengesellschaft, Munchen (DE)

(21) Appl. No.: 13/569,015

(22) Filed: Aug. 7, 2012

(30) Foreign Application Priority Data
Aug. 8, 2011 (DE) 10 2011 080 608.3

(51) Int. Cl. G21K 1/00; B26D 3/00

(52) U.S. Cl. 378/154; 83/13

(57) ABSTRACT

A method for producing a scattered radiation grid for x-ray radiation by stacking strips and an associated scattered radiation grid are provided. The strips are cut out of a laminate that includes a first layer, a second layer, and a third layer. The first layer is formed from a first material that absorbs x-ray radiation, and the second layer is formed from a second material that is permeable to the x-ray radiation. A second material that is highly permeable to the x-ray radiation and reduces the attenuation of the scattered radiate on grid may be used.

This application claims the benefit of DE 10 2011 080 608.3, filed on Aug. 8, 2011.

### BACKGROUND

The present embodiments relate to a method for producing a scattered radiation grid from stacked strips and an associated scattered radiation grid.

Heavy demands are placed on the image quality of x-ray recordings in x-ray image technology. For this type of recording (e.g., as performed in medical x-ray diagnostics), an object to be examined is x-rayed from a virtually punctiform x-ray source. The attenuation distribution of the x-ray radiation on a side of the object opposite the x-ray source is captured in two dimensions. The x-ray radiation attenuated by the object may also be captured line by line (e.g., in computed tomography systems). Flat-panel detectors are increasingly used as x-ray detectors in addition to x-ray films and gas detectors. Flat-panel detectors may have a matrix-type arrangement of opto-electronic semiconductor components as photoelectric receivers. Each pixel of the x-ray recording may correspond to the attenuation of the x-ray radiation through the object on a straight-line axis from the punctiform x-ray source to the location on the detector surface corresponding to the pixel. X-rays that hit the x-ray detector in a straight line from the punctiform x-ray source on this axis are known as primary rays.

The x-ray radiation emitted from the x-ray source is however scattered in the object because of unavoidable interactions, so that scattered rays (e.g., secondary rays) hit the detector in addition to the primary rays. The scattered rays, which, as a function of properties of the object, may cause more than 90% of the entire signal modulation of an x-ray detector in diagnostic images, represent a noise source and make fine differences in contrast harder to identify.

To reduce the proportion of scattered radiation hitting the detectors, scattered radiation grids are inserted between the object and the detector. Scattered radiation grids include regularly arranged structures that absorb x-ray radiation, between which through-channels or through-slots are formed to enable the primary radiation to pass through with as little attenuation as possible. These through-channels or through-slots are aligned toward the focus in the case of focused scattered radiation grids in accordance with the distance from the punctiform x-ray source (e.g., the distance from the focus of the x-ray tube). In the case of unfocused scattered radiation grids, the through-channels or through-slots are aligned across the whole surface of the scattered radiation grid vertically to the surface thereof. However, this results in a marked loss of primary radiation at the edges of the image recording, as a larger proportion of the incident primary radiation hits the absorbent regions of the scattered radiation grid at these points.

To achieve a high image quality, very high demands are placed on the properties of x-ray scattered radiation grids. The scattered rays may be absorbed as much as possible, while as high a proportion as possible of primary radiation passes through the scattered radiation grid unattenuated. A diminution of the proportion of scattered radiation hitting the detector surface may be achieved using a large ratio of the height of the scattered radiation grid to the thickness or the diameter of the through-channels or through slots (e.g., using a high grid ratio (an aspect ratio)).

There are various techniques and corresponding methods for producing scattered radiation grids for x-ray radiation. Thus, for example, publication DE 102 41 424 A1 describes various production methods and scattered radiation grids. For example, lamellar scattered radiation grids that are made up of strips of lead and paper are known. The lead strips absorb the secondary radiation, while the paper strips lying between the lead strips form the through-slots for the primary radiation. Alternatively, aluminum may also be used instead of paper, thereby reducing the costs of the production process. The paper grid uses paper with a low attenuation as a slit or window. The aluminum grid uses aluminum as a slit or window that has a significantly higher attenuation compared to paper. The advantage of the aluminum grid is that the aluminum grid may be produced using simple process steps and may be repaired if there are defects in individual process steps. As a result, the efficiency during production is greater.

### SUMMARY AND DESCRIPTION

The present embodiments may obviate one or more of the drawbacks or limitations in the related art. For example, a production process for scattered radiation grids and an associated scattered radiation grid with lower attenuation are provided.

Strips of laminate are used to produce the scattered radiation grid. A material or product including two or more layers glued flat together is a “laminate.” The layers may include the same or different materials. The production of a laminate is a “lamination.” The layers are aluminum, plastic or paper and lead. An x-ray scattered radiation grid is produced by stacking and compressing or joining laminate strips.

In one embodiment, a method for producing a scattered radiation grid for x-ray radiation includes stacking strips. The strips are cut from a laminate that includes a first layer, a second layer and a third layer. The first layer is formed from a first material that absorbs x-ray radiation, and the second layer is formed from a second material that is permeable to x-ray radiation. The present embodiments offer the advantage that a second material may be used that is highly permeable to x-ray radiation and reduces the attenuation of the scattered radiation grid. A burr used for the cohesion of the strips is formed in the third layer when cutting the strips.

In a development of the method, the first material may be lead, and the second material may be plastic or paper.

In a further embodiment, the third layer may be formed from a third material that is permeable to x-ray radiation. The third material may be aluminum.

In one embodiment, the first layer may be 20 μm thick, the second layer may be 80-300 μm thick, and the third layer may be 10 μm thick.

In a further embodiment, the third layer may be formed from a third material that absorbs x-ray radiation.

In one embodiment, the third material is lead.

In another embodiment, the first layer may be 10 μm thick, the second layer 80 may be 300 μm thick, and the third layer may be 10 μm thick.

In one embodiment, a scattered radiation grid for x-ray radiation is formed from stacked strips. The strips include a laminate. The laminate includes a first layer made of a first material that absorbs x-ray radiation, a second layer made of a second material that is permeable to x-ray radiation, and a third layer.

### BRIEF DESCRIPTION OF THE DRAWINGS

FIG. 1 shows a flow chart of one embodiment of a production method for a scattered radiation grid; and

FIG. 2 shows a cross-section of one embodiment of a strip for producing a scattered radiation grid.

### DETAILED DESCRIPTION OF THE DRAWINGS

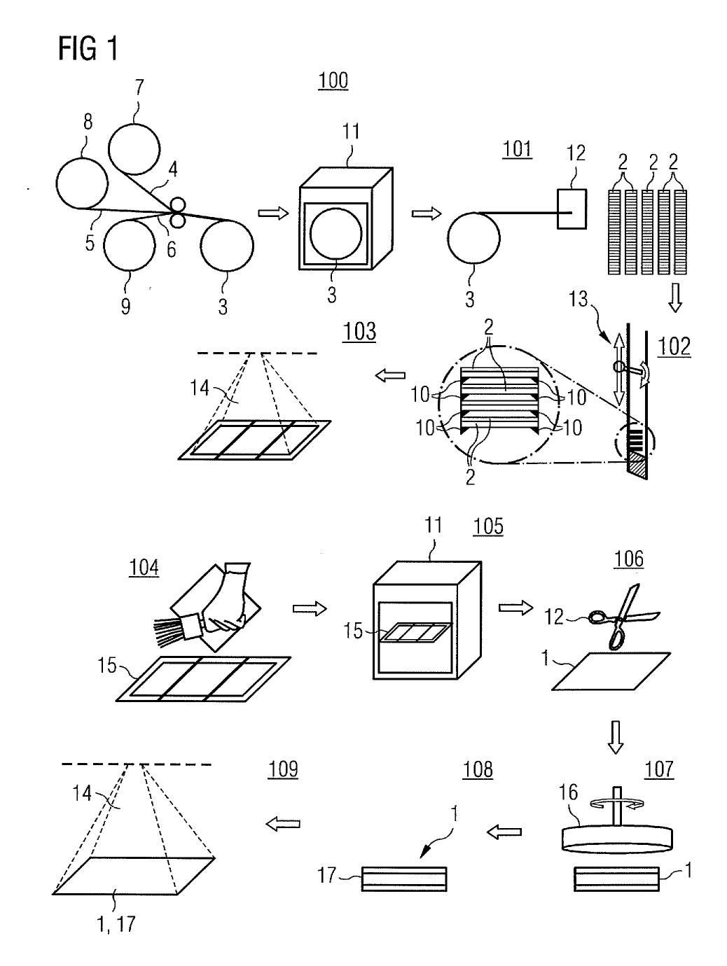

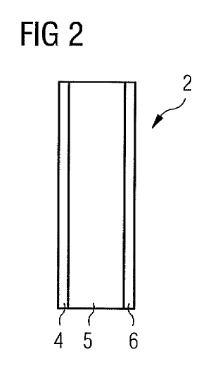

FIG. 1 shows a procedure for producing one embodiment of a scattered radiation grid. In method act 100, a laminate 3 is produced by bonding a foil-like first layer made of a first material 7 (e.g., lead or tungsten) that absorbs x-ray radiation, a foil-like second layer 5 made of a second material 8 (e.g., plastic or paper) that is permeable to the x-ray radiation, and a foil-like third layer 6 made of a third material 9. The third layer 6 is harder compared to the second layer 5. The third material may either be permeable to x-ray radiation (e.g., aluminum) or impermeable to the x-ray radiation (e.g., lead). The three layers 4, 5, 6 are laminated in a furnace 11 (e.g., glued flat to one another). When the second material 5 is plastic, this already has the adhesive function. Otherwise, adhesives are applied as bonding layers when joining the layers 4, 5, 6. The thicknesses of the layers 4, 5, 6 are described below with reference to FIG. 2.

In act 101, the laminate 3 is cut into strips 2 using a cutting device 12. The strips 2 are approximately 50 cm×4 cm in size and 130 to 330 μm thick. In act 102, the strips 2 are stacked using a stacking device 13. A required focus alignment may be set. Burrs 10 formed in the third layer 6 when cutting the strips 2 are pressed into the adjoining first layer 4 when the strips 2 are joined and thus bond the strips 2 detachably to one another. If no burr 10 is formed during cutting, the burr 10 may also be formed by subsequent stamping. The burrs 2 are approximately 0.5 μm high. In act 103, the focus is checked using x-ray radiation 14. If an error is found, the strips 2 may be detached from one another and stacked and joined once again.

In act 104, the joined, stacked strips 15 are coated with epoxy resin and, in act 105, are heated in the furnace 11, so that the stacked strips 15 adhere permanently to one another. In act 106, the scattered radiation grid 1 is cut out of the stacked strips 15 using the cutting device 12. In act 107, the surfaces of the scattered radiation grid 1 are ground. In act 108, the grid 1 is provided with a housing 17 and, in act 109, undergoes final testing using x-ray radiation 14.

The use of a laminate with an aluminum and a lead layer allows the aluminum to be shaped plastically (e.g., burr formation) in the case of a plastic intermediate layer.

FIG. 2 shows a cross-section through a strip 2 of one embodiment of a scattered radiation grid. A first layer 4, a second layer 5 and a third layer 6 are shown. The first layer 4 is made of lead and is approximately 20 μm thick. The second layer 5 is made of plastic and is 100 to 300 μm thick. The third layer 6 is made of aluminum and is approximately 10 μm thick. Alternatively, the third layer 6 may be made of lead. In this case, both the first layer 4 and the third layer 6 are each 10 μm thick.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for producing a scattered radiation grid for x-ray radiation by stacking strips, the method comprising:
cutting the strips out of a laminate that comprises a first layer, a second layer and a third layer, the first layer being formed from a first material that absorbs x-ray radiation and the second layer being formed from a second material that is permeable to the x-ray radiation.

2. The method as claimed in claim 1, wherein the first material is lead, and the second material is plastic or paper.

3. The method as claimed in claim 1, wherein the third layer is formed from a third material that is permeable to the x-ray radiation.

4. The method as claimed in claim 3, wherein the third material is aluminum.

5. The method as claimed in one of claims 1, wherein the first layer is 20 μm thick, the second layer is 80-300 μm thick, and the third layer is 10 μm thick.

6. The method as claimed in claim 1, wherein the third layer is formed from a third material that absorbs the x-ray radiation.

7. The method as claimed in claim 6, wherein the third material is lead.

8. The method as claimed in claim 6, wherein the first layer is 10 μm thick, the second layer is 80-300 μm thick, and the third layer is 10 μm thick.

9. The method as claimed in claim 2, wherein the third layer is formed from a third material that is permeable to the x-ray radiation.

10. The method as claimed in one of claims 2, wherein the first layer is 20 μm thick, the second layer is 80-300 μm thick, and the third layer is 10 μm thick.

11. A scattered radiation grid for x-ray radiation, the scattered radiation grid comprising:
stacked strips comprising a laminate, the laminate comprising:
a first layer made of a first material that absorbs the x-ray radiation;
a second layer made of a second material that is permeable to the x-ray radiation; and
a third layer.

12. The scattered radiation grid as claimed in claim 11, wherein the first material is lead, and the second material is plastic or paper.

13. The scattered radiation grid as claimed in claim 11, wherein the third layer comprises a third material that is permeable to the x-ray radiation.

14. The scattered radiation grid as claimed in claim 13, wherein the third material is aluminum.

15. The scattered radiation grid as claimed in claim 11, wherein the first layer is 20 μm thick, the second layer is 80-300 μm thick, and the third layer is 10 μm thick.

16. The scattered radiation grid as claimed in claim 11, wherein the third layer comprises a third material that absorbs the x-ray radiation.

17. The scattered radiation grid as claimed in claim 16, wherein the third material is lead.

18. The scattered radiation grid as claimed in claim 16, wherein the first layer is 10 μm thick, the second layer is 80-300 μm thick, and the third layer is 10 μm thick.

19. The scattered radiation grid as claimed in claim 16, wherein a material that absorbs the x-ray radiation is allocated to the first layer and to the third layer.

20. The scattered radiation grid as claimed in claim 12, wherein the third layer comprises a third material that is permeable to the x-ray radiation.
